(19) United States
(12) Patent Application Publication
(10) Pub. No.: US 2021/0047071 A1
(43) Pub. Date: Feb. 18, 2021

(54) Carrier For Containers

(71) Applicant: Graphic Packaging International, LLC, Atlanta, GA (US)

(72) Inventors: Raymond R. Spivey, SR., Mableton, GA (US); Colin P. Ford, Woodstock, GA (US); John Murdick Holley, JR., Lawrenceville, GA (US); Ana Gonzalez, Barcelona (ES); Jon Thompson, Bristol (GB); Brian Smalley, Bristol (GB)

(21) Appl. No.: 17/088,645

(22) Filed: Nov. 4, 2020

Related U.S. Application Data
(62) Division of application No. 15/399,283, filed on Jan. 5, 2017, now Pat. No. 10,858,145.
(60) Provisional application No. 62/274,979, filed on Jan. 5, 2016.

(51) Int. Cl. B65D 5/54; B65D 71/64; B65D 5/02; B65D 5/42; B65D 5/468; B65D 71/36

(52) U.S. Cl. CPC B65D 5/5495; B65D 71/0048; B65D 5/02; B65D 5/4266; B65D 2571/0066; B65D 5/4608; B65D 71/36; B31B 2241/001; B65D 2571/00438; B65D 5/4275

(57) ABSTRACT

A carrier includes a front portion with a first plurality of panels and a back portion with a second plurality of panels. The first plurality of panels at least partially surrounds a front interior space for receiving at least one container and includes a front panel, a front central panel, and at least one front side panel. The second plurality of panels at least partially surrounds a back interior space for receiving at least one container and includes a back panel, a back central panel, and at least one back side panel. The front central panel and the back central panel are separably connected at a line of weakening and are at least partially in face-to-face contact in a first configuration of the carrier, the carrier is positionable to a second configuration wherein the front portion and the back portion are at least partially separated at the line of weakening.

### CROSS-REFERENCE TO RELATED APPLICATION

The present application is a divisional of U.S. application Ser. No. 15/399,283, filed Jan. 5, 2017, which claims the benefit of U.S. Provisional Patent Application No. 62/274,979, filed on Jan. 5, 2016.

### INCORPORATION BY REFERENCE

The disclosures of U.S. patent application Ser. No. 15/399,283, filed on Jan. 5, 2017, and U.S. Patent Application No. 62/274,979, filed on Jan. 5, 2016, are hereby incorporated by reference for all purposes as if presented herein in their entirety.

### BACKGROUND OF THE DISCLOSURE

The present disclosure generally relates to carriers or cartons for holding and displaying containers. More specifically, the present disclosure relates to basket-style carriers that are separable into a first portion and a second portion.

### SUMMARY OF THE DISCLOSURE

According to one aspect of the disclosure, a carrier for holding a plurality of containers is disclosed. The carrier comprises a front portion that comprises a first plurality of panels and a back portion that comprises a second plurality of panels. The first plurality of panels at least partially surrounds a front interior space for receiving at least one container of the plurality of containers and comprises a front panel, a front central panel, and at least one front side panel. The second plurality of panels at least partially surrounds a back interior space for receiving at least one container of the plurality of containers and comprises a back panel, a back central panel, and at least one back side panel. The front central panel and the back central panel are separably connected at a line of weakening and are at least partially in face-to-face contact in a first configuration of the carrier. The carrier is positionable to a second configuration wherein the front portion and the back portion are at least partially separated at the line of weakening.

According to another aspect of the disclosure, a blank for forming a carrier for holding a plurality of containers is disclosed. The blank comprises a front portion that comprises a first plurality of panels and a back portion that comprises a second plurality of panels. The first plurality of panels is for at least partially surrounding a front interior space of a front portion of the carrier when the carrier is formed from the blank and comprises a front panel, a front central panel, and at least one front side panel. The front interior space of the carrier is for receiving at least one container of the plurality of containers. The second plurality of panels is for at least partially surrounding a back interior space of a back portion of the carrier when the carrier is formed from the blank and comprises a back panel, a back central panel, and at least one back side panel. The back interior space of the carrier is for receiving at least one container of the plurality of containers. The front central panel and the back central panel are separably connected at a line of weakening and are for being in at least partial face-to-face contact in a first configuration of the carrier when the carrier is formed from the blank. The front portion of the carrier and the back portion of the carrier are positionable to a second configuration wherein the front portion of the blank and the back portion of the blank are at least partially separated at the line of weakening when the carrier is formed from the blank.

According to another aspect of the disclosure, a method for forming a carrier for holding a plurality of containers is disclosed. The method comprises providing a blank that comprises a front portion and a back portion. The front portion of the blank comprises a first plurality of panels comprising a front panel, a front central panel, and at least one front side panel. The back portion of the blank comprises a second plurality of panels comprising a back panel, at least one back side panel, and a back central panel foldably connected to the front central panel at a line of weakening. The method also comprises folding the first plurality of panels and the second plurality of panels into a first configuration of the carrier so that the first plurality of panels at least partially surrounds a front interior space of a front portion of the carrier and the second plurality of panels at least partially surrounds a back interior space of the carrier. The front central panel and the second central panel are in at least partial face-to-face contact in the first configuration of the carrier, each of the front interior space and the back interior space for receiving at least one container of the plurality of containers.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an outer surface of a blank for forming a carrier according to a first exemplary embodiment of the disclosure.

FIG. 2 is a plan view of an interior surface of the blank of FIG. 1 in a partially folded configuration.

FIG. 3 is a perspective view of the blank of FIG. 1 in a partially folded configuration.

FIG. 4 is a perspective view of a carrier formed from the blank of FIG. 1 in an open configuration.

FIG. 5 is a schematic view of a container-loading operation of the carrier of FIG. 4.

FIG. 6 is a perspective view of the carrier of FIG. 4 in a closed configuration and including containers.

FIG. 7 is a perspective view of the carrier of FIG. 6 separated into a first portion and a second portion.

FIG. 8 is a plan view of an outer surface of a blank for forming a carrier according to a second exemplary embodiment of the disclosure.

FIG. 9 is a perspective view of the blank of FIG. 8 in a partially folded configuration.

FIG. 10 is a perspective view of a carrier formed from the blank of FIG. 8 in an open configuration.

FIG. 11 is a perspective view of the carrier of FIG. 10 in a closed configuration and including containers.

FIG. 12 is a perspective view of the carrier of FIG. 11 separated into a first portion and a second portion.

FIG. 13 is a plan view of an outer surface of a blank for forming a carrier according to a third exemplary embodiment of the disclosure.

FIG. 14 is a perspective view of the blank of FIG. 13 in a partially folded configuration.

FIG. 15 is a perspective view of a carrier formed from the blank of FIG. 13 in an open configuration.

FIG. 16 is a perspective view of the carrier of FIG. 15 in a closed configuration and including containers.

FIG. 17 is a perspective view of the carrier of FIG. 16 partially separated into a first portion and a second portion.

FIG. 18 is a plan view of an outer surface of a blank for forming a carrier according to a fourth exemplary embodiment of the disclosure.

FIG. 19 is a perspective view of the blank of FIG. 18 in a partially folded configuration.

FIG. 20 is a perspective view of a carrier formed from the blank of FIG. 18 in an open configuration.

FIG. 21 is a perspective view of the carrier of FIG. 20 in a closed configuration and including containers.

FIG. 22 is a perspective view of the carrier of FIG. 21 partially separated into a first portion and a second portion.

Corresponding parts are designated by corresponding reference numbers throughout the drawings.

### DETAILED DESCRIPTION

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., glass bottles) at least partially disposed within the carrier embodiments. In this specification, the terms “lower,” “bottom,” “upper,” “top,” “front,” and “back” indicate orientations determined in relation to fully erected carriers.

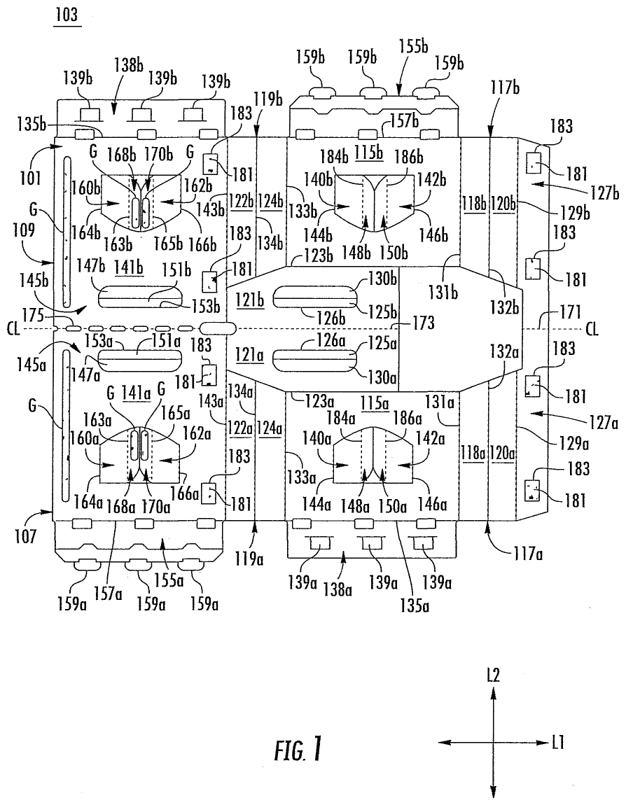

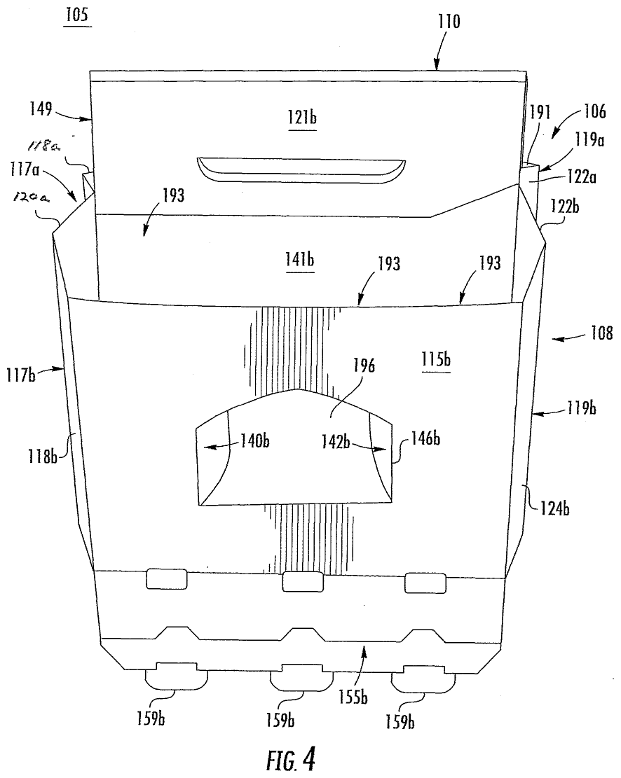

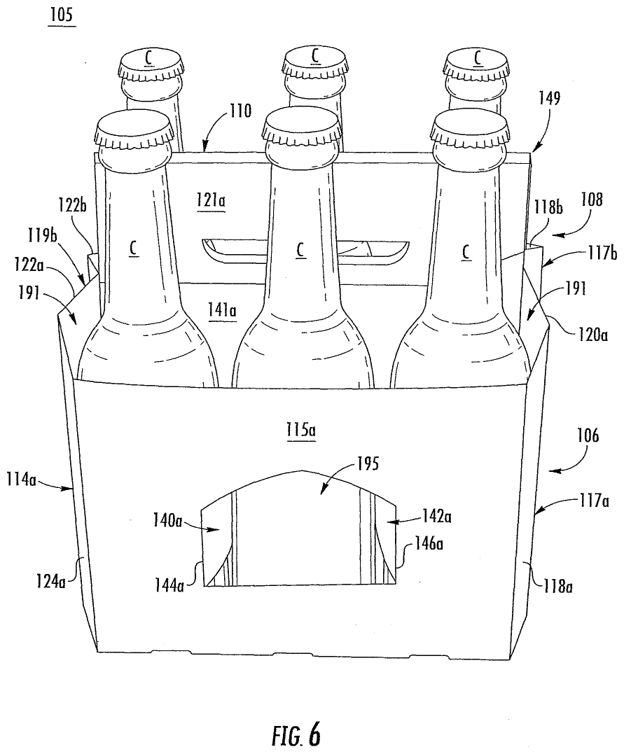

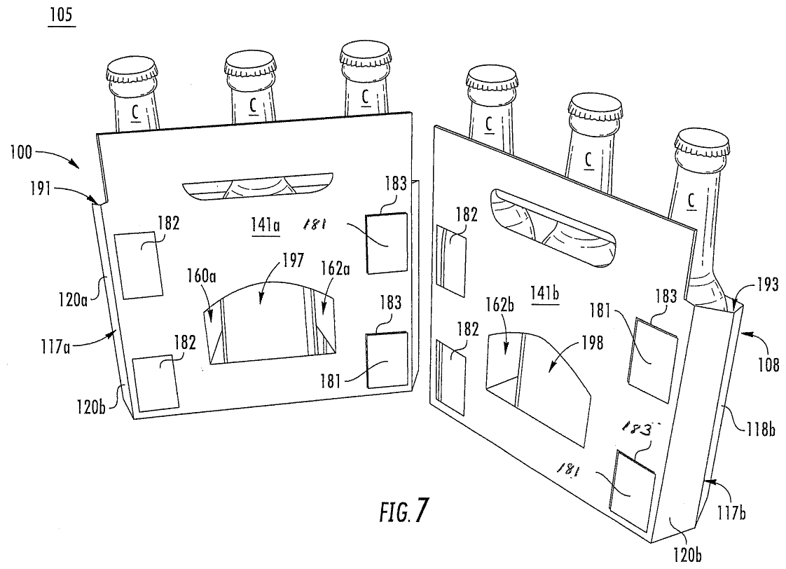

FIG. 1 is a plan view of an exterior side 101 of a blank 103 used to form a package or basket-style carrier 105 (FIG. 4), in accordance with a first exemplary embodiment of the present disclosure. As shown in FIGS. 4-7, the carrier 105 is sized to contain six containers C, three containers C being contained in a front portion 106 of the carrier 105 and three containers C being contained in a back portion 108 of the carrier 105. In a first configuration of the carrier 105 (FIG. 6), the front portion is attached to the back portion 108. In the illustrated embodiment, the containers C are beverage bottles, but the containers C could be any other suitable type and size of container without departing from the disclosure. The carrier 105 may be sized and shaped to hold more or less than six containers C. As will be discussed in greater detail below, the front portion 106 of the carrier 105 and the back portion 108 of the carrier 105 are separable along a line of weakening 110 that extends across the carrier 105 to allow the front portion 106 to be fully or partially separated from the back portion 108 in a second configuration of the carrier 105 (FIG. 7). In one embodiment, the separated front portion 106 and the separated back portion 108 each have three containers C, and the separated portions 106, 108 can be placed independently in a refrigerator or other location. In other embodiments, the front portion 106 and the back portion 108 of the carrier 105 can remain foldably attached in the second configuration after partial separation. Also, the carrier 105 can hold more or less than six containers C, with each of the front portion 106 and the back portion 108 of the carrier 105 holding more or less than three containers C without departing from the disclosure.

As shown in FIG. 1, the blank 103 has a longitudinal axis L1 and a lateral axis L2. The blank 103 has a front portion 107 for forming the front portion 106 of the carrier 105, and a back portion 109 for forming the back portion 108 of the carrier 105. In one embodiment, the front portion 107 and the back portion 109 are separated by the longitudinal centerline CL of the blank 103, as shown. As discussed in more detail below, the blank 103 is formed into the carrier 105 by folding the blank 103 about the centerline CL so that the front portion 107 and the back portion 109 are overlapped.

In the illustrated embodiment, the front portion 107 of the blank 103 comprises a front panel 115a foldably connected to a first side panel 117a and a second side panel 119a. The front portion 107 includes a front handle reinforcement flap 121a separated from the second side panel 119a and the front panel 115a by a cut 123a. The front handle reinforcement flap 121a includes an opening 130a and a handle flap 125a foldably connected to the front handle reinforcement flap 121a at a fold line 126a and adjacent to the opening 130a. An adhesive flap 127a is foldably connected to the first side panel 117a at a lateral fold line 129a. Lateral fold lines 131a, 133a, foldably connect a respective first and second side panel 117a, 119a to the front panel 115a and the first and second side panels 117a, 119a include respective lateral fold lines 132a, 134a dividing the side panels 117a, 119a into respective first and second portions 118a, 122a and 120a, 124a. The front portion 107 includes a first bottom panel 138a foldably connected to the front panel 115a at a longitudinal fold line 135a. In one embodiment, the first bottom panel 138a includes female locking features 139a, which may be configured as openings, as shown. As shown in FIG. 1, the front panel 115a includes two divider flaps 140a, 142a foldably connected to the front panel 115a at respective lateral fold lines 144a, 146a. Free edges of each divider flap 140a, 142a include an adhesive flap 148a, 150a foldably connected to the respective divider flaps 140a, 142a at respective lines of weakening 184a, 186a, as shown. The front panel 115a could be otherwise shaped, arranged, and/or configured, and could have other features, without departing from the disclosure.

In one embodiment, and as shown, the front portion 107 includes a front or first central panel 141a foldably connected to the second side panel 119a at a lateral fold line 143a. The first central panel 141a includes a handle portion 145a with handle features including a handle opening 147a and handle flap 151a foldably connected to the central panel 141a at a longitudinal fold line 153a and adjacent to the handle opening 147a. The blank 103 includes a second bottom panel 155a foldably connected to the central panel 141a along a longitudinal fold line 157a. The second bottom panel 155a includes male locking features 159a, which may be configured as tabs, as shown. As shown in FIG. 1, the central panel 141a includes two divider flaps 160a, 162a foldably connected to the central panel 141a at respective lateral fold lines 164a, 166a. Free edges of each divider flap 160a, 162a include an adhesive flap 168a, 170a foldably connected to the respective divider flaps 160a, 162a at respective lines of weakening 163a, 165a. The central panel 141a could be otherwise shaped, arranged, and/or configured, and could have other features, without departing from the disclosure. For example, the first bottom panel 138a could be foldably connected to the central panel 141a and the second bottom panel 155a could be foldably connected to the front panel 115a without departing from the disclosure.

In the illustrated embodiment, the features of the back portion 109 of the blank 103 include a back panel 115b, a first side panel 117b, a second side panel 119b, a central adhesive flap 127b, and a central panel 141a that are generally a mirror-image of the corresponding panels or flaps of the front portion 107. Corresponding components (e.g., panels, flaps, fold lines, cuts, etc.) have been designated by corresponding reference numbers that differ by the “a” or “b” suffix, with the “a” components corresponding to the front portion 107 and the “b” components corresponding to the back portion 109 of the blank 103. As shown in FIG. 1 and in contrast to the front portion 107, the back portion 109 of the blank 103 includes the first bottom panel 138b having female locking features 139b and being foldably connected to the central panel 141b, and the second bottom panel 155b having male locking features 159b and being foldably connected to the back panel 115b. In one embodiment, and as shown, the blank 103 includes a tear line 171 between the adhesive flaps 127a, 127b of the front portion 107 and the back portion 109, a tear line 173 between the handle reinforcement flaps 121a, 121b of the front portion 107 and the back portion 109, and a tear line 175 between the central panels 141a, 141b of the front portion 107 and the back portion 109. As noted below, when the carrier 105 is formed, the tear lines 171, 173, 175 combine, e.g., at least partially overlap, to form the line of weakening 110 (FIG. 4) in the carrier 105 for separating the front portion 106 and the back portion 108 of the carrier 105. One or more of the tear lines 171, 173, 175 could be other lines of weakening (e.g., fold lines, cut lines, etc.) without departing from the disclosure.

As shown, the blank 103 can include one or more removable connection patches or portions 181 in the central panels 141a, 141b and the adhesive flaps 127a, 127b. The removable connection patches 181 can be defined by a line of weakening 183 such as a tear line. As shown, one or more of the removable patches 181 can be coated with an adhesive G, such as a glue, to facilitate assembly and separation operations of the front portion 106 and the back portion 108 of the carrier 105. In embodiments, the removable patches 181 of the front portion 107 of the blank 103 may be coated with adhesive G, while the removable patches 181 of the back portion 109 of the blank 103 may be devoid of adhesive G. In other embodiments, removable patches 181 of the blank may be provided with adhesive G in a different pattern, e.g., an alternating or complementary pattern. The removable patches 181 can be otherwise shaped, arranged, configured, located, and/or omitted without departing from the disclosure.

Any of the panels, flaps, fold lines, cuts, or other features could be otherwise shaped, arranged, and/or omitted from the blank 103 without departing from the disclosure. The blank 103 could be sized and/or shaped to accommodate more or less than six containers without departing from this disclosure.

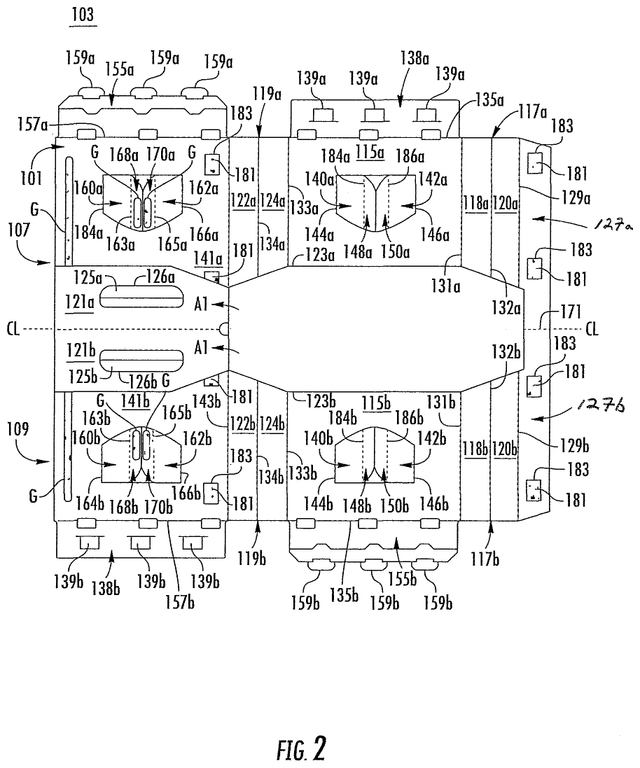

Still referring to FIG. 1, and referring additionally to FIG. 2, in one exemplary method of erection, the blank 103 is positioned with its exterior surface 101 facing down and with an interior surface 102 of the blank 103 facing up, and the carrier 105 may be erected from the blank 103 by respectively folding the handle reinforcement flaps 121a, 121b in the direction of A1 along fold lines 143a, 143b so that the handle reinforcement flaps 121a, 121b overlap the central panels 141a, 141b on the interior surface 102 of the blank 103 such that the handle flaps 125a, 151a of the front portion 107 are overlapped and the handle flaps 125b, 151b of the back portion 109 are overlapped. As shown, adhesive G can be selectively applied to portions of the blank 103, e.g., along portions of the central panels 141a, 141b and the reinforcement panels 121a, 121b, and the adhesive flaps 148a, 150a, 168a, 170a, 148b, 150b, 168b, and 170b, as shown, to facilitate erection of the blank 103. In embodiments, adhesive G may be applied in a different pattern along the blank 103.

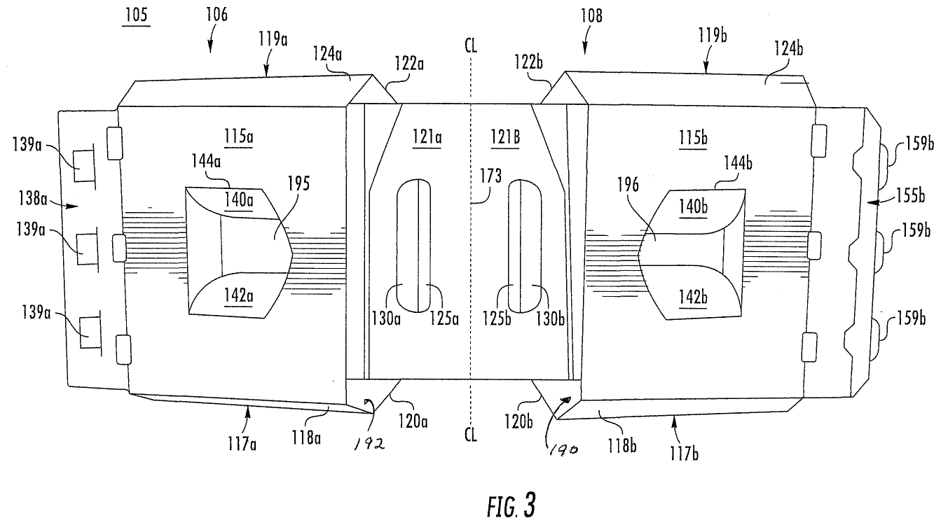

Referring additionally to FIG. 3, the front panel 115a and back panel 115b are folded about fold lines 134a, 134b to be brought into face-to-face contact with the respective central panels 141a, 141b. The adhesive flaps 127a, 127b are brought into face-to-face contact with the marginal portion of the respective central panels 141a, 141b and adhesively attached thereto by adhesive G such that a front interior space 190 and a back interior space 192 of the carrier 105 is defined. In such a configuration, the divider flaps 140a, 162a can be folded about respective fold lines 144a, 166a toward one another and connected by the engagement and adhesive attachment of the respective adhesive flaps 148a, 170a, and the divider flaps 142a, 160a can be folded about respective fold lines 146a, 164a toward one another and connected by the engagement and adhesive attachment of the adhesive flaps 150a, 168a. Similarly, the divider flaps 140b, 162b can be folded about respective fold lines 144b, 166b toward one another and connected by the engagement and adhesive attachment of the respective adhesive flaps 148b, 170b, and the divider flaps 142b, 160b can be folded about respective fold lines 146b, 164b toward one another and connected by the engagement and adhesive attachment of the adhesive flaps 150b, 168b. Such assembly results in a partially-formed configuration of the carrier 105 having the front portion 106 and back portion 108, as shown. The adhered divider flaps 142a, 160a and 140a, 162a form an opening or window 195 in the front panel 115a and an opening or window 197 (FIG. 7) in the central panel 142a such that the one or more containers C disposed in the carrier 105 are visible and/or can be accessed. The respective adhered divider flaps 142b, 160b and 140b, 162b form an opening or window 196 in the back panel 115b and an opening or window 198 (FIG. 7) in the central panel 142b.

Still referring to FIG. 1, and referring additionally to FIG. 4, the front portion 106 and back portion 108 of the partially-formed carrier 105 having respective open bottoms is folded about the overlapped tear lines 171, 173, 175 along the central longitudinal axis CL so that the central panels 141a, 141b are brought into face-to-face contact and can be adhesively attached at the connection patches 181. The carrier 105 can be further opened by positioning the first and second side panels 117a, 117b and 119a, 119b in substantially perpendicular relation to the front and back panels 115a, 115b and the central panels 141a, 141b, and with the central panels 141a, 141b and the front and back panels 115a, 115b in parallel relationship with one another. A handle 149, as shown, extends upwardly along a central portion of the carrier 105. As shown, the adhered divider flaps 142a, 160a and 140a, 162a extend between the central panel 141a and the front panel 115a to form three container-receiving spaces 191 in the front interior space 190 (FIG. 3) in the front portion 106. Similarly, the adhered divider flaps 142b, 160b and 140b, 162b extend between the central panel 141b and the back panel 115b to form three container-receiving spaces 193 in the back interior space 192 (FIG. 3) in the back portion 108. Thus, as illustrated, the carrier 105 is provided having an open configuration with bottom panels 138a, 155a and 138b, 155b disengaged from one another.

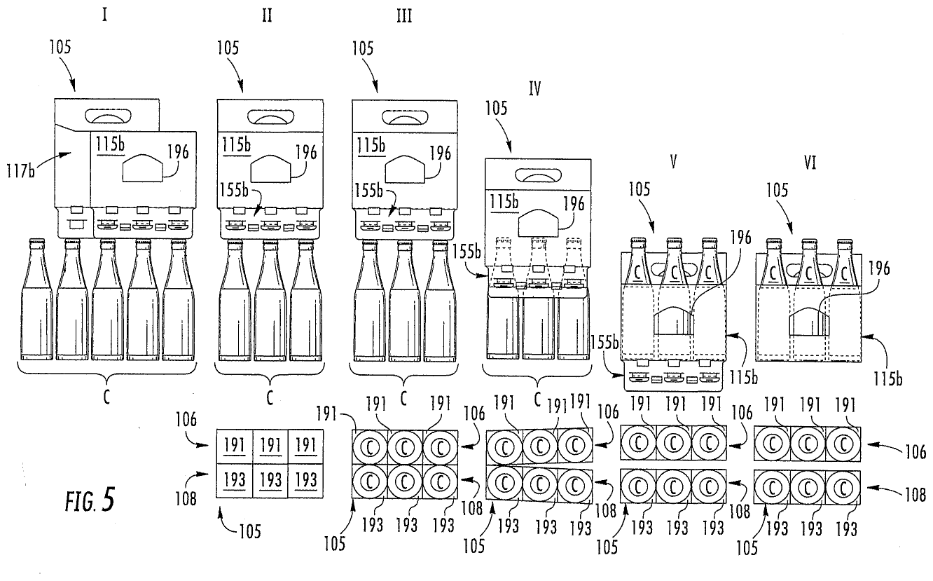

Referring additionally to FIG. 5, in one embodiment, the opened front portion 106 and opened back portion 108 can be lowered onto groups of containers C so that three containers C are received in the front portion 106 and three containers C are received in the back portion 108. Such a loading operation can be accomplished, for example, with one or more carriers 105 being moved along an overhead carrier assembly (not shown) in concert with groups of containers C being carried along a conveyor or belt (not shown). At the upstream end of the loading operation, in a loading stage I, the carrier 105 having the open bottom panels 138a, 155a and 138b, 155b is fed to the forming area, as illustrated. In stage II of the loading operation, the carrier 105 is progressed through a folding/positioning apparatus (not shown) and opened as described above. In stage III of the loading operation, as shown, the open-bottomed carrier 105 is positioned over a 3×3 group of containers C. In stage IV of the loading operation, as shown, the carrier 105 is lowered onto the group of containers C such that the containers C are received in the container-receiving spaces 191, 193 of the carrier 105. As shown, in stage V and stage VI of the loading operation, the bottom panels 138a, 155a are overlapped to close the bottom of the front portion 106 of the carrier 105 and the bottom panels 138b and 155b are overlapped to close the bottom of the back portion 108 of the carrier 105 so that the containers C are contained in the carrier 105. Such engagement may be accomplished for example, with the male locking features 159a, 159b interlocked with a respective female locking feature 139a, 139b to interlock the bottom panels 138a, 155a and 138b, 155b. The bottom panels 138a, 155a and 138b, 155b can be interlocked or secured by other means (e.g., adhesive or locking features that are otherwise shaped) without departing from the disclosure.

Referring to FIGS. 1 and 7, the front portion 106 and the back portion 108 of the carrier 105 can be torn along the tear line 110, e.g., such that tear lines 171, 173, 175 are collectively torn, so that the front portion 106 and the back portion 108 of the carrier 105 are separated from one another, as shown. When the front portion 106 and back portion 108 are separated, the portion of the connection patches 181 of one of the central panels 141a, 141b and the adhesive flaps 127a, 127b can separated and adhesively attached to the other of the central panels 141a, 141b and the adhesive flaps 127a, 127b. Such separation of the removable patches 181 from one or the other of the front portion 106 and the back portion 108 of the carrier 105 may be determined, for example, by the relative strength of the connection of a given removable patch 181 provided by a respective line of weakening 183. In one embodiment, the separation of the removable patch 181 from one panel 141a, 141b or flap 127a, 127b and the adhesive attachment of the removable patch 181 to the opposite panel 141a, 141b or flap 127a, 127b can cause an opening 182 in one or more of the panels 141a, 141b or flaps 127a, 127b corresponding to the shape of the line of weakening 183 that forms the removable patch 181. In other embodiments, the removable patches 181 may only partially separate from a respective panel 141a, 141b or flap 127a, 127b upon separation of the front portion 106 and the back portion 108 of the carrier 105. The removable patches 181 could be otherwise shaped, arranged, configured, and/or activated without departing from the disclosure.

In this regard, the blank 103 can be provided and assembled as described herein to provide a carrier 105 having a front portion 106 and a back portion 108 that are separable from one another to provide at least two individual portions that contain at least one container C. Such separate portions of the carrier 105 can be transported, stored, or otherwise used separately from one another or in cooperation.

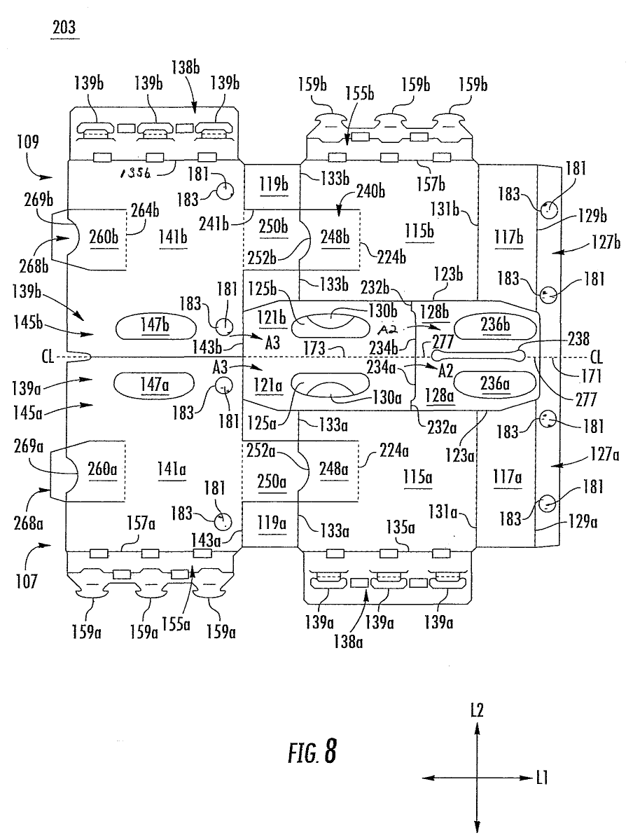

FIGS. 8-12 illustrate a second exemplary embodiment of the disclosure similar to the first embodiment, and like or similar reference numbers are indicated throughout the drawings to indicate like or similar features. FIG. 8 illustrates a blank 203 for forming the carrier 205 of the second embodiment. As with the first embodiment, the blank 203 includes a front portion 107 for forming the front portion 106 of the carrier 205 and a back portion 109 for forming the back portion 108 of the carrier 205. As shown in FIG. 8, the blank 203 includes a second handle reinforcement flap 128a, 128b foldably connected to a respective handle reinforcement flap 121a, 121b at a line of weakening 230 that can include lateral fold lines 232a, 232b and cuts 234a, 234b extending between the lateral fold lines 232a, 232b. The second handle reinforcement flaps 128a, 128b include respective openings 236a, 236b and are separated by a central opening 238 extending along the centerline CL of the blank 203 and a pair of tear lines 277 that form a portion of a line of weakening 210 that includes tear lines 171, 173, 175 and 277, as shown. In the second embodiment, the blank 203 includes a divider flap 240a foldably connected to the front panel 115a at a fold line 244a and foldably connected to the central panel 141a at a portion of the fold line 143a. As shown, the divider flap 240 is separated from the front panel 115a and the second side panel 119a by laterally-extending cuts 241a, 243a. The divider flap 240 includes a first portion 248a foldably connected to the front panel 115a at the fold line 244a and a second portion 250a foldably connected to the central panel 141a at the portion of the fold line 143a. In one embodiment, the first portion 248a and the second portion 250a are separated by a line of weakening 252a that includes a cut extending from portions of the fold line 133a. The central panel 141a includes a divider flap 260a foldably connected to the central panel 141a at a lateral fold line 264a and having a free edge including an adhesive flap 268a foldably connected to the divider flap 260a at a line of weakening 269a. In the second embodiment, as illustrated, the divider flap 260a extends to the edge of the blank 203. The back portion 109 of the blank 203 includes divider flaps 240b, 260b and other features similar to the front portion 107.

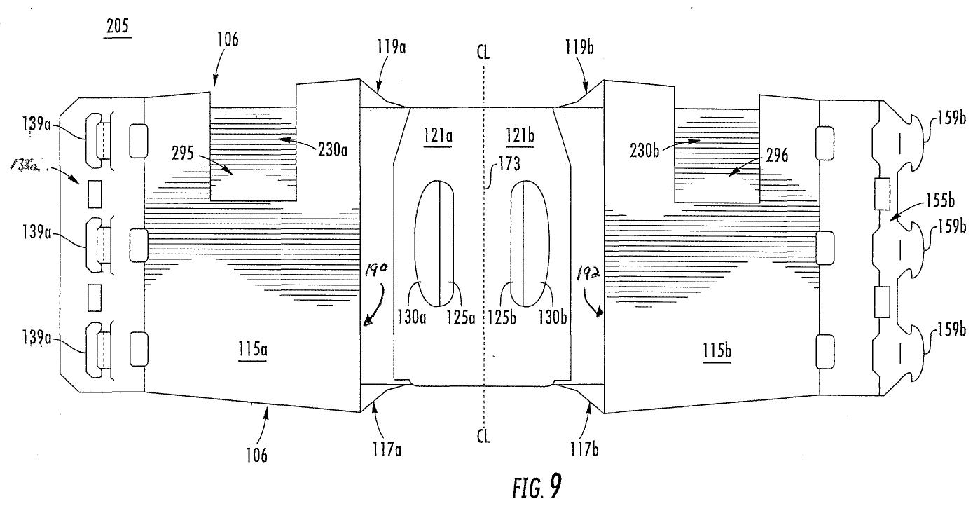

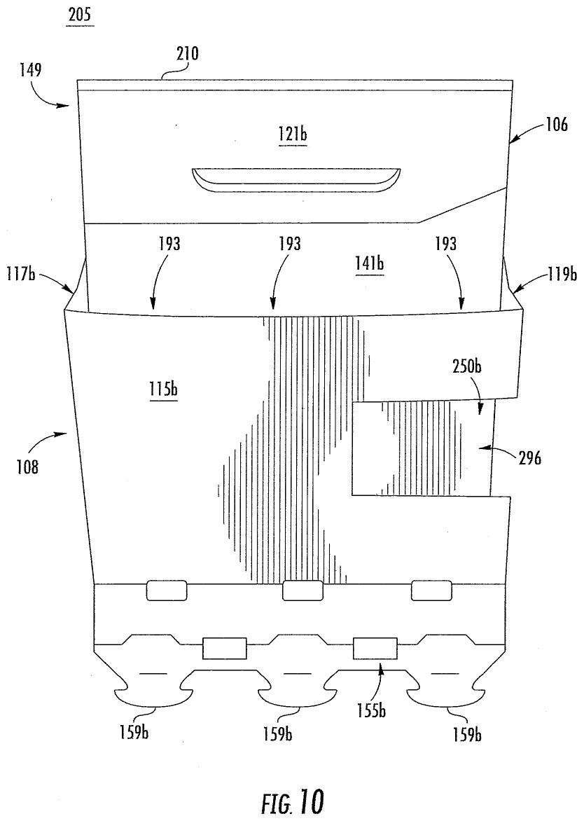

Still referring to FIG. 8, and referring additionally to FIGS. 9 and 10, the carrier 205 can be formed in a similar manner as the carrier 105 of the first embodiment. In particular, the second handle reinforcement flaps 128a, 128b can be folded along the line of weakening 230 in the direction of A2 along fold lines 232a, 232b so that the second handle reinforcement flaps 128a, 128b overlap the respective first handle reinforcement flaps 121a, 121b. The overlapped first and second handle reinforcement flaps 121a, 121b and 128a, 128b can be folded in the direction of A3 along fold lines 143a, 143b so that the handle reinforcement flaps 121a, 128a and 121b, 128b overlap the respective central panels 141a, 141b. The front panel 115a and back panel 115b can be folded about fold lines 143a, 143b to be brought into face-to-face contact with the respective central panels 141a, 141b. The adhesive flaps 127a, 127b are brought into face-to-face contact with the marginal portion of the respective central panels 141a, 141b and adhesively attached thereto, for example, by an adhesive. The front portion 106 and back portion 108 of the partially formed carrier 205 having respective open bottoms is folded about the overlapped tear lines 171, 173, 175, 277 along the central longitudinal axis CL so that the central panels 141a, 141b are brought into face-to-face contact and can be adhesively attached to provide the open-bottomed carrier 205 shown in FIG. 10.

The divider flaps 240a, 240b may be positioned such that the respective first portions 248a, 248b and second portions 250a, 250b are folded along the respective lines of weakening 252a, 252b and positioned inwardly along the carrier 205 so that the second portions 250a, 250b of the respective divider flaps 240a, 240b overlap the central panels 141a, 141b and the first portions 248a, 248b of the respective divider flaps 240a, 240b extend between the central panels 141a, 141b and the respective front panel 115a or back panel 115b. In this regard, the divider flaps 240a, 240b are disposed at right angles, e.g., in an L-shaped configuration, to define interior corners of the carrier 205 that provide a divider between two respective container-receiving spaces 191, 193 of the respective front interior space 190 and back interior space 192 of the carrier 205. The divider flaps 260a, 260b also extend between the central panels 141a, 141b and the respective front panel 115a and back panel 115b and can be adhesively attached to the respective front panel 115a and back panel 115b by the adhesive flaps 268a, 268b. In the second embodiment, as illustrated, the divider flaps 240a, 240b form a respective window 295, 296 in a corner of the respective front portion 106 and back portion 108 of the carrier 205. Similarly, the divider flaps 260a, 260b from a respective window 297, 298 in a portion, e.g., on respective panels 141a, 141b, of opposite corners of the respective front portion 106 and back portion 108 of the carrier 205. The windows 295, 296, 297, 298 allow portions of the containers C to be visible and/or at least partially accessed from the exterior of the carrier 205 and one or more of the windows 295, 296, 297, 298 could be otherwise shaped, arranged, position, configured, and/or omitted without departing from the disclosure.

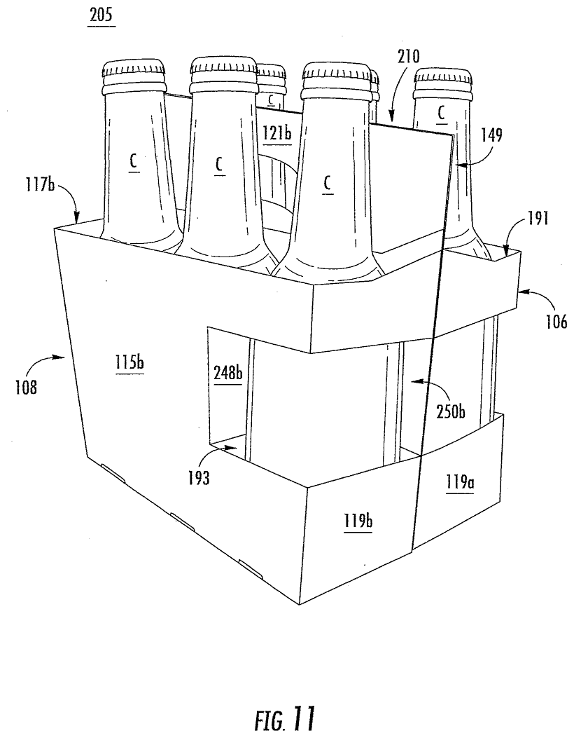

Referring to FIGS. 8 and 11, the carrier 205 can be loaded with containers C and the bottom panels 138a and 155a can be overlapped to close the bottom of the front portion 106 of the carrier 205 and the bottom panels 138b and 155b can be overlapped to close the bottom of the back portion 108 of the carrier 205 so that the containers C are contained in the carrier 205. Such loading and closure of the carrier 205 can be accomplished in a similar manner to that described with regard to carrier 105 described above.

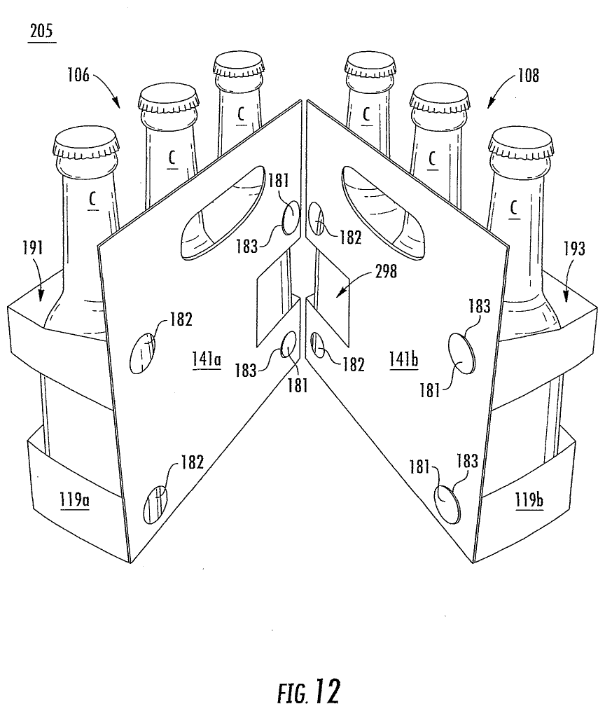

Referring additionally to FIG. 12, the front portion 106 and the back portion 108 of the carrier 205 can be torn along the tear line 210, e.g., such that tear lines 171, 173, 175, and 277 are collectively torn, such that the front portion 106 and the back portion 108 of the carrier 205 are separable from one another, as shown. Removable patches 181, as shown, may facilitate separation of the front portion 106 and the back portion 208 of the carrier 205 as described above with respect to carrier 105.

In this regard, blank 203 can be provided and assembled as described herein to provide a carrier 205 having a front portion 106 and a back portion 108 that are separable from one another to provide at least two individual portions 106, 108 that contain at least one container C. Such separate portions of the carrier 205 can be transported, stored, or otherwise used separately from one another or in cooperation. The portions 106, 108 of the carrier 205 incorporate additional windows, e.g., windows 295, 296, 297, 298, as compared to carrier 105 described above, which allows for different visibility and/or accessibility of containers C stored therein.

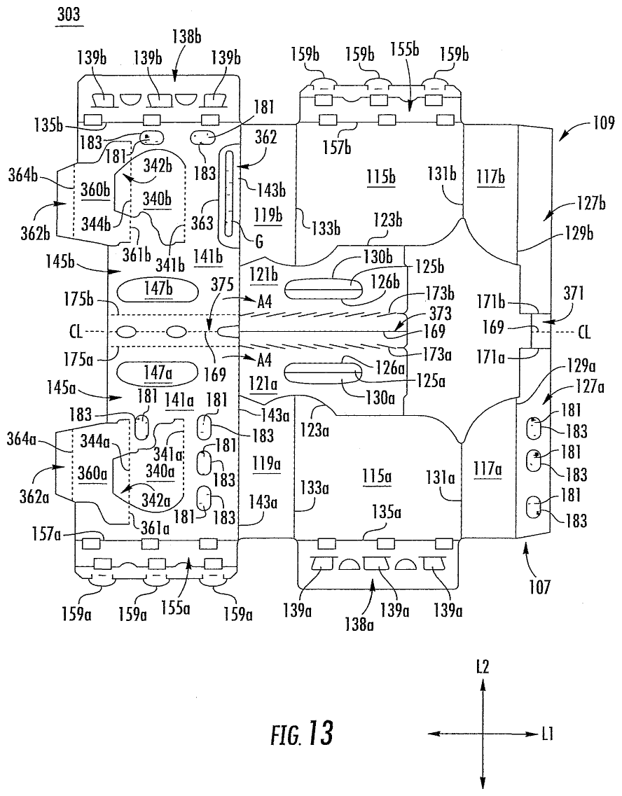

FIGS. 13-17 illustrate a third exemplary embodiment of the disclosure similar to the first and second embodiments, and like or similar reference numbers are indicated throughout the drawings to indicate like or similar features. FIG. 13 illustrates a blank 303 for forming a carrier 305 of the third embodiment. As with the previous embodiments, the blank 303 includes a front portion 107 for forming the front portion 106 of the carrier 305 and a back portion 109 for forming the back portion 108 of the carrier 305. As shown in FIG. 13, the blank 303 includes two divider flaps 340a, 360a and 340b, 360b foldably connected to each respective central panel 141a, 141b along respective fold lines 341a, 361a and 341b, 361b. Each divider flap 340a, 360a, 340b, 360b has a free edge portion including a respective adhesive flap 342a, 362a, 342b, 362b foldably attached to the respective flaps 340a, 360a, 340b, 360b at respective fold lines 344a, 364a, 344b, 364b. In the third embodiment, as shown, the blank 303 includes tear strips 371, 373, 375 extending along the centerline CL across the respective adhesive flaps 127a, 127b, handle reinforcement flaps 121a, 121b, and central panels 141a, 141b. The tear strips 371, 373, 375 are formed by respective tear lines 171a, 173a, 175a in the front portion 107 of the blank 303 and respective tear lines 171b, 173b, 175b in the back portion 109 of the blank 303, and include a central fold line 169 extending along the centerline CL. As shown in FIG. 13, the central panel 141b of the back portion 109 of the blank 303 includes an attachment flap 362 defined by a tear line 363 extending on a portion of the central panel 141b and being foldably connected to the second side panel 119b at a portion of the fold line 143b. In embodiments, the attachment flap 362 may be disposed on the central panel 141a of the front portion of the blank 303, or an attachment flap 362 may be disposed on each of the central panels 141a, 141b of the blank 303.

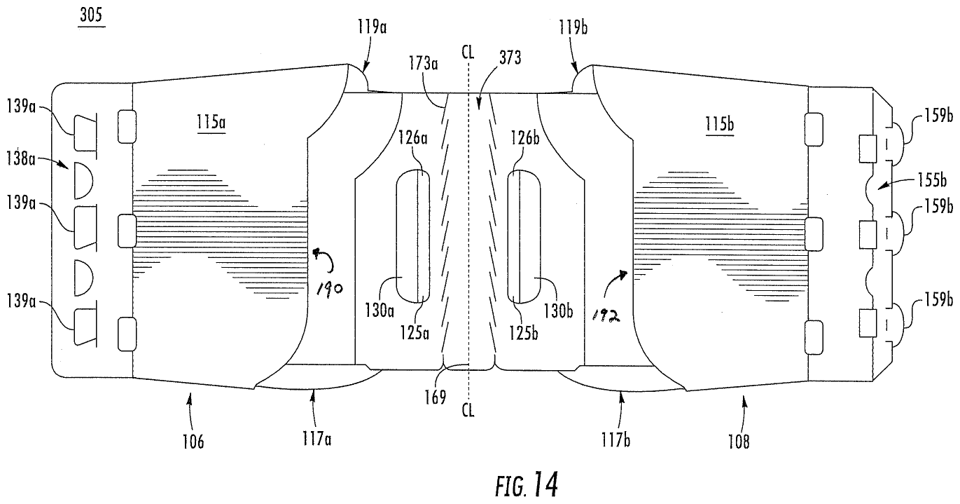

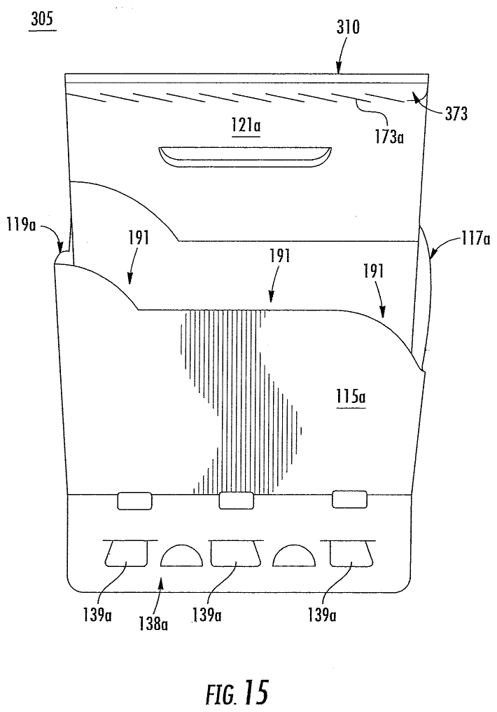

Still referring to FIG. 13, and referring additionally to FIGS. 14 and 15, the carrier 305 can be formed in a similar manner as the carrier 105 of the first embodiment and the carrier 205 of the second embodiment. In particular, the handle reinforcement flaps 121a, 121b can be folded along the fold lines 143a, 143b in the direction of A4 so that the handle reinforcement flaps 121a, 121b overlap the respective central panels 141a, 141b. The front panel 115a and back panel 115b can be folded about fold lines 143a, 143b to be brought into face-to-face contact with the respective central panels 141a, 141b. The adhesive flaps 127a, 127b are brought into face-to-face contact with the marginal portion of the respective central panels 141a, 141b and adhesively attached thereto, for example, by an adhesive. The front portion 106 and back portion 108 of the partially formed carrier 305 having respective open bottoms is folded about the central fold line 169 so that the central panels 141a, 141b are brought into face-to-face contact and can be adhesively attached, for example, along removable patches 181 disposed along the central panels 141a, 141b and the adhesive flap 127a.

The divider flaps 340a, 360a are positioned to divide the front interior space 190 of the front portion 106 of the carrier 305 into three container-receiving spaces 191 by extending from the central panel 141a to the front panel 115a and being adhesively connected to the front panel 115a. Similarly, the divider flaps 340b, 360b divide the back interior space 192 of the back portion 108 of the carrier 305 into three container-receiving spaces 193 by extending from the central panel 141b to the back panel 115b and being adhesively connected to the back panel 115b. In one embodiment, as illustrated, when the blank 303 is formed into the carrier 305, the attachment flap 362 in the central panel 141b of the back portion 109 of the blank 303 is adhesively attached to the central panel 141a of the front portion 107a when the central panels 141a, 141b are brought into face-to-face contact. The tear strips 371, 373, 375 of the blank 303 are positioned to form the line of weakening 310 (e.g., separation feature, tear strip, etc.) that extends across the top portion of the carrier 305.

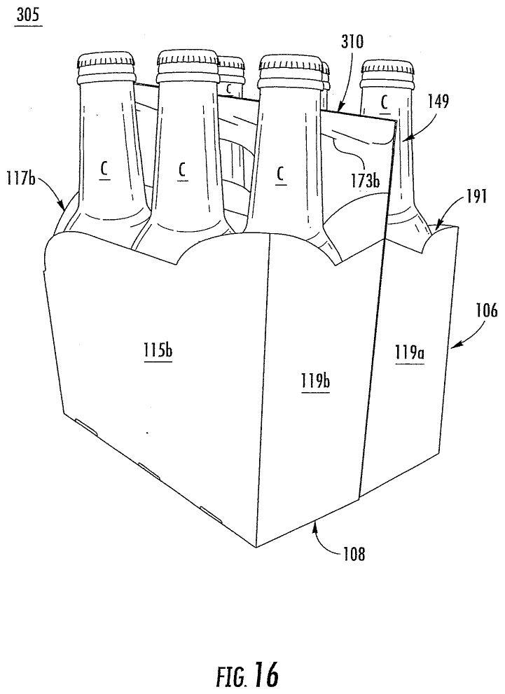

Referring to FIGS. 8 and 16, the carrier 305 can be loaded with containers C and the bottom panels 138a and 155a can be overlapped to close the bottom of the front portion 106 of the carrier 305 and the bottom panels 138b and 155b can be overlapped to close the bottom of the back portion 108 of the carrier 305 so that the containers C are contained in the carrier 305 in a similar manner as described above with respect to carriers 105, 205.

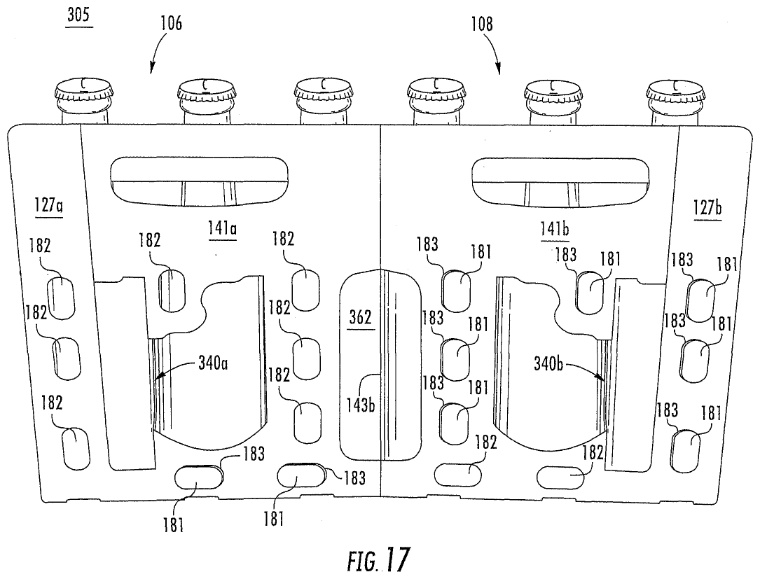

Referring to FIGS. 13 and 17, the tear strip 310 can be removed from the carrier 305 so that the front portion 106 and the back portion 108 of the carrier 305 can be pulled apart. Removable patches 181, as shown, may facilitate separation of the front portion 106 and the back portion 208 of the carrier 305 as described above with respect to carriers 105, 205. As shown in FIG. 17, the back portion 108 can remain attached to the front portion 106 by the adhesive attachment of the attachment flap 362 that is attached to the central panel 141a of the front portion 106 of the carrier 305. In this regard, upon breaching of the line of weakening 310, e.g., removal of the tear strips 371, 373, 375, the front portion 106 and the back portion 108 of the carrier 305 are hingably connected to one another via the attachment flap 362. As shown in FIG. 17, the front portion 106 and the back portion 108 of the carrier 305 can be positioned in a side-by-side relationship with the front portion 106 foldably connected to the back portion 108 and positioned in a 1×6 arrangement. The front portion 106 and back portion 108 of the carrier 305 can be otherwise positioned and could be free from foldable connection to each other so that front portion 106 and the back portion 108 are independently positionable in a refrigerator or on a display shelf. The carrier 305 can be formed by other steps and can have other features without departing from the disclosure.

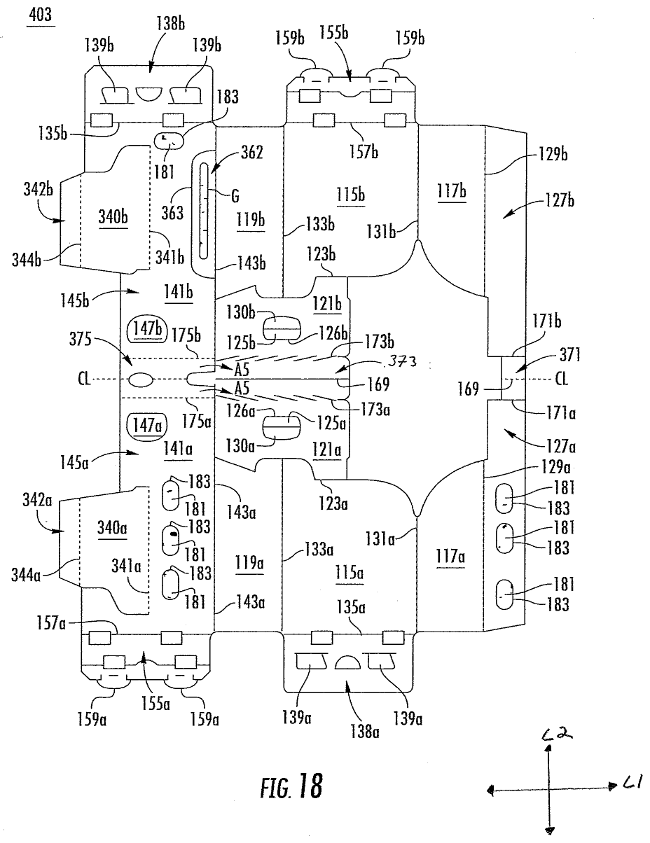

FIGS. 18-22 illustrate a fourth exemplary embodiment of the disclosure similar to the first, second, and third embodiments, and like or similar reference numbers are indicated throughout the drawings to indicate like or similar features. The fourth embodiment of the carrier 405 is similar to the third embodiment 305, except that the fourth embodiment is a 2×2 configuration for holding four containers C, with two containers in the front portion 106 and two containers in the back portion 108. FIG. 18 illustrates a blank 403 for forming the carrier 405 of the fourth embodiment. The blank 403 includes a single divider flap 340a foldably connected to the central panel 141a at a fold line 341a in the front portion 107 of the blank 403 and a single divider flap 340b foldably connected to the central panel 141b at a fold line 341b in the back portion 109 of the blank 403. The divider flaps 340a, 340b divide the respective front interior space 190 of the front portion 106 and the back interior space 192 of the back portion 108 of the carrier 405 into two container-receiving spaces 191, 193.

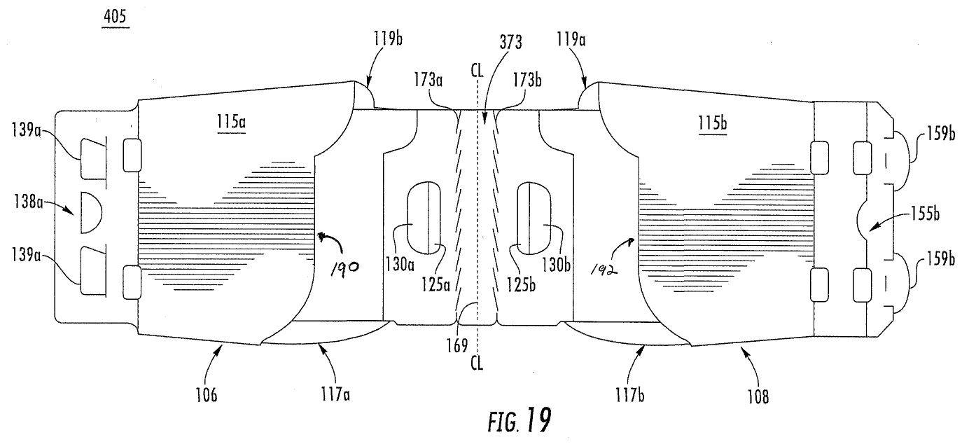

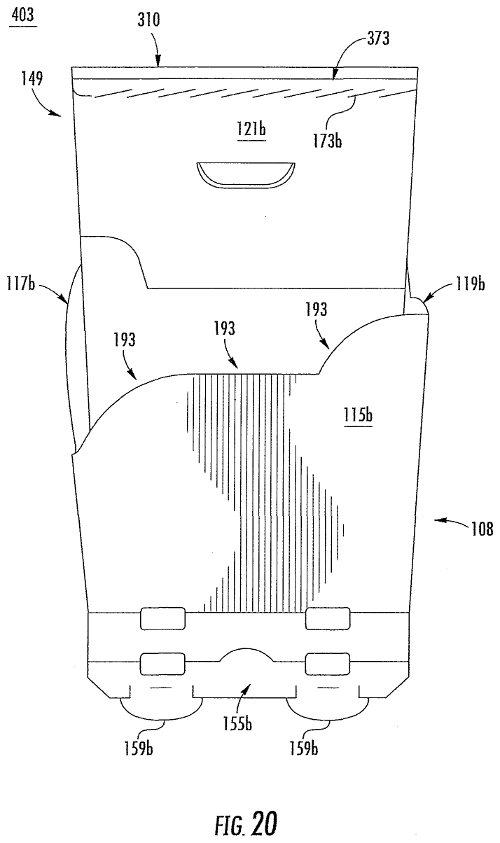

Still referring to FIG. 18, and referring additionally to FIGS. 19 and 20, the carrier 405 can be formed in a similar manner as the carrier 105 of the first embodiment, the carrier 205 of the second embodiment, and the carrier 305 of the third embodiment. In particular, the handle reinforcement flaps 121a, 121b can be folded along the fold lines 143a, 143b in the direction of A5 so that the handle reinforcement flaps 121a, 121b overlap the respective central panels 141a, 141b. The front panel 115a and back panel 115b can be folded about fold lines 143a, 143b to be brought into face-to-face contact with the respective central panels 141a, 141b. The adhesive flaps 127a, 127b are brought into face-to-face contact with the marginal portion of the respective central panels 141a, 141b and adhesively attached thereto, for example, by an adhesive. The front portion 106 and back portion 108 of the partially formed carrier 405 having respective open bottoms is folded about the central fold line 169 so that the central panels 141a, 141b are brought into face-to-face contact and can be adhesively attached, for example, along removable patches 181 disposed along the central panels 141a, 141b and the adhesive flap 127a.

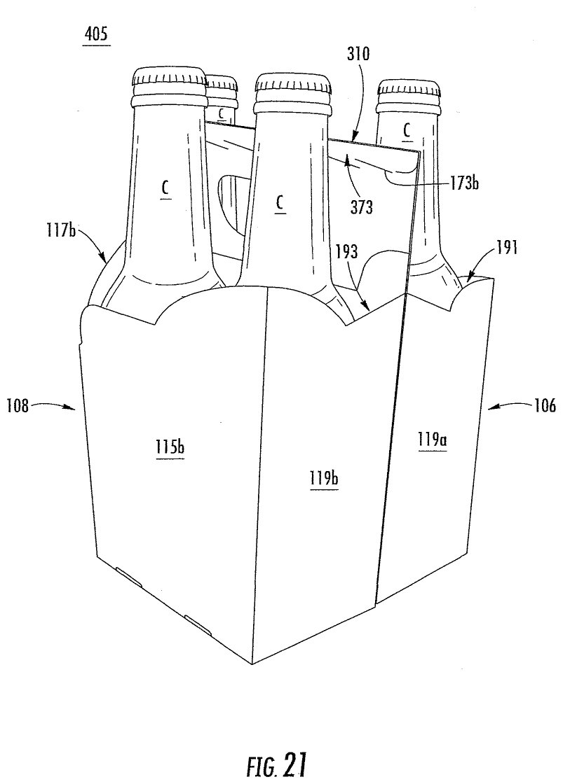

Referring to FIGS. 20 and 21, the carrier 345 can be loaded with containers C and the bottom panels 138a and 155a can be overlapped to close the bottom of the front portion 106 of the carrier 405 and the bottom panels 138b and 155b can be overlapped to close the bottom of the back portion 108 of the carrier 305 so that the containers C are contained in the carrier 405 in a similar manner as described above with respect to carriers 105, 205, and 305.

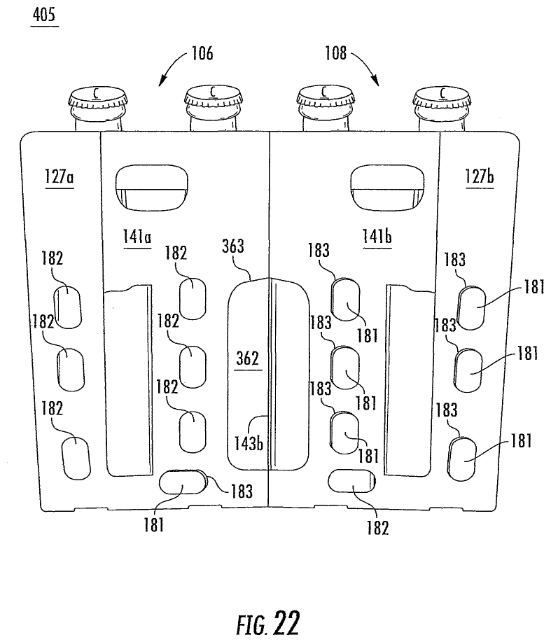

Referring to FIGS. 21 and 22, as with the third embodiment, the front portion 106 and the back portion 108 of the carrier 405 are separable by removal of the tear strip 310 that is comprised of the three tear strips 371, 373, 375 of the adhesive flaps 127a, 127b, the handle reinforcement flaps 121a, 121b, and the central panels 141a, 141b. Also, upon removal of the tear strip 310, the back portion 108 remains foldably connected to the front portion 106 by the attachment flap 362 that is secured to the central panel 141a of the front portion, for example, with adhesive G. As shown, the carrier 405 can be positioned in a 1×4 configuration with the front portion 106 and back portion 108 in a side-by-side arrangement. Alternatively, the front portion 106 and the back portion 108 of the carrier 405 could be separable without remaining foldably connected. The carrier 405 can be formed by other steps and can have other features without departing from the disclosure.

The carriers 105, 205, 305, 405 of the present disclosure allow the carriers to be loaded with containers C in the front and back portions 106, 108 of the carrier in a 2× configuration (e.g., 2×3, 2×2, etc., prior to separation) at a higher rate of container filler speed than if separate 1× carriers (e.g., 1×2, 1×3, etc.) are filled. The carriers 105, 205, 305, 405 are 2× carriers that can be separated into 1× carriers (corresponding to the separated front portion 106 and back portion 108) allows the container filler to be run at full speed when filling the 2× carriers. In this regard, the produced 2× carriers can be selectively separated post-processing according to the needs of a retailer or user. Also, the packaging machine running the 2× carriers 105, 205, 305, 405 can run at lower speeds to keep up with the same container filling speed than if 1× carriers were run thereby reducing wear and tear on the machine and components and increasing product filling line efficiency. The lower speeds available for the packaging machine running the 2× carriers are due to the fact that twice as many containers are being loaded into the 2× carriers than the 1× carriers. Thus, the higher rate of container filler speed and the reduced speeds of the packaging machine that the 2× carriers 105, 205, 305, 405 allow increase the efficiency in output of the packaging line that is used to package the containers C in the carriers.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A blank for forming a carrier for holding a plurality of containers, the blank comprising:
a front portion of the blank that comprises a first plurality of panels for at least partially surrounding a front interior space of a front portion of the carrier when the carrier is formed from the blank, the front interior space for receiving at least one container of the plurality of containers, the first plurality of panels comprising a front panel, a front central panel, and at least one front side panel; and
a back portion of the blank that comprises a second plurality of panels for at least partially surrounding a back interior space of a back portion of the carrier when the carrier is formed from the blank, the back interior space for receiving at least one container of the plurality of containers, the second plurality of panels comprising a back panel, a back central panel, and at least one back side panel,
the front central panel and the back central panel are separably connected at a line of weakening and are for being in at least partial face-to face contact in a first configuration of the carrier when the carrier is formed from the blank, the front portion of the carrier and the back portion of the carrier are positionable to a second configuration wherein the front portion of the blank and the back portion of the blank are at least partially separated at the line of weakening when the carrier is formed from the blank.

2. The blank of claim 1, wherein the line of weakening comprises a tear line.

3. The blank of claim 1, wherein the line of weakening comprises a tear strip positioned at an upper portion of the carrier when the carrier is formed from the blank.

4. The blank of claim 3, wherein the tear strip comprises an upper portion of each of the front central panel and the back central panel.

5. The blank of claim 4, wherein the tear strip includes a central fold line on a centerline of the blank.

6. The blank of claim 1, wherein at least one of the front portion of the blank and the back portion of the blank comprises a removable patch for being adhesively secured to the other of the at least one of the front portion of the blank and the back portion of the blank when the carrier is formed from the blank.

7. The blank of claim 6, wherein the removable patch is at least partially defined by a line of weakening.

8. The blank of claim 7, wherein the front portion of the blank comprises a first removable patch and the back portion of the blank comprises a second removable patch, the first removable patch for being aligned with and in face-to-face contact with the second removable patch in the first configuration of the carrier when the carrier is formed from the blank.

9. The blank of claim 8, wherein the first removable patch is adhesively connected to the second removable patch and the second removable patch is separated from the back portion of the blank in the second configuration of the carrier when the carrier is formed from the blank.

10. The blank of claim 9, wherein the back portion of the blank comprises an opening defined by the line of weakening defining the second removable patch in the second configuration of the carrier when the carrier is formed from the blank.

11. The blank of claim 1, wherein a front handle portion extends from the front central panel and a back handle portion extends from the back central panel, the front handle portion and the back handle portion are for forming a handle of the carrier when the carrier is formed from the blank.

12. The blank of claim 11, wherein a front handle reinforcement flap and a back handle reinforcement flap are for respectively overlapping with a respective front handle portion and a back handle portion when the carrier is formed from the blank.

13. The blank of claim 12, wherein the front handle reinforcement flap and back handle reinforcement flap are foldably separably connected at a portion of the line of weakening.

14. The blank of claim 1, wherein at least one of the front portion of the blank and the back portion of the blank comprises an attachment flap foldably connected to a respective one of the front central panel and the back central panel, the attachment flap being adhesively attached to the other of the front central panel and the back central panel when the carrier is formed from the blank, the front portion of the blank and the back portion of the blank remain foldably connected at the attachment flap in the second configuration of the carrier when the carrier is formed from the blank.

15. The blank of claim 1, wherein the front portion of the blank comprises at least one front divider flap foldably connected to at least one panel of the first plurality of panels, the front divider flap divides the front interior space into at least two front container-receiving spaces when the carrier is formed from the blank.

16. The blank of claim 15, wherein the back portion of the blank comprises at least one back divider flap foldably connected to at least one panel of the second plurality of panels, the back divider flap divides the back interior space into at least two back container-receiving spaces when the carrier is formed from the blank.

17. The blank of claim 16, wherein the at least one front divider flap is foldably connected to the front central panel and the at least one back divider flap is foldably connected to the back central panel.

18. The blank of claim 17, wherein the at least one front divider flap comprises a first portion foldably connected to the front panel and a second portion foldably connected to the first portion and the front central panel, the front divider flap is for forming a window in the front portion of the carrier when the carrier is formed from the blank.

19. The blank of claim 15, wherein the at least one front divider flap comprises a first front divider flap foldably connected to the front central panel and a second front divider flap foldably connected to the front panel, the first front divider flap is for being adhesively connected to the second front divider flap when the carrier is formed from the blank.

20. The blank of claim 1, wherein the first plurality of panels comprises a first front bottom panel foldably connected to the front panel and a second front bottom panel foldably connected to the front central panel.

21. The blank of claim 20, wherein the second plurality of panels comprises a first back bottom panel foldably connected to the back central panel and a second back bottom panel foldably connected to the back panel.

22. The blank of claim 21, wherein the first front bottom panel and the second front bottom panel cooperate to at least partially define the front interior space and the first back bottom panel and the second back bottom panel cooperate to at least partially define the back interior space when the carrier is formed from the blank.

23. A method of forming a carrier for holding a plurality of containers, comprising:
providing a blank comprising:
a front portion of the blank comprising a first plurality of panels comprising a front panel, a front central panel, and at least one front side panel; and
a back portion of the blank comprising a first plurality of panels comprising a back panel, at least one back side panel, and a back central panel separably connected to the front central panel at a line of weakening; and
folding the first plurality of panels and the second plurality of panels into a first configuration of the carrier so that the first plurality of panels at least partially surrounds a front interior space of a front portion of the carrier and the second plurality of panels at least partially surrounds a back interior space of the carrier, the front central panel and the second central panel are in at least partial face-to-face contact in the first configuration of the carrier, each of the front interior space and the back interior space for receiving at least one container of the plurality of containers.

24. The method of claim 23, further comprising positioning the front portion of the carrier and the back portion of the carrier into a second configuration of the carrier in which the front portion of the carrier and the back portion of the carrier are at least partially separated at the line of weakening.

25. The method of claim 23, wherein the line of weakening comprises a tear line.

26. The method of claim 23, wherein the line of weakening comprises a tear strip positioned at an upper portion of the carrier when the first plurality of panels and the second plurality of panels are folded.

27. The method of claim 26, wherein the tear strip comprises an upper portion of each of the front central panel and the back central panel.

28. The method of claim 27, wherein the tear strip includes a central fold line on a centerline of the carrier.

29. The method of claim 23, wherein at least one of the front portion of the carrier and the back portion of the carrier comprises a removable patch for being adhesively secured to the other of the at least one of the front portion of the carrier and the back portion of the carrier when the first plurality of panels and the second plurality of panels are folded.

30. The method of claim 29, wherein the removable patch is at least partially defined by a line of weakening.

31. The method of claim 30, wherein the front portion of the carrier comprises a first removable patch and the back portion of the carrier comprises a second removable patch, the first removable patch is aligned with and in face-to-face contact with the second removable patch in the first configuration of the carrier when the first plurality of panels and the second plurality of panels are folded.

32. The method of claim 31, wherein the first removable patch is adhesively connected to the second removable patch and the second removable patch is separated from the back portion of the blank in the second configuration of the carrier when the first plurality of panels and the second plurality of panels are folded.

33. The method of claim 32, wherein the back portion of the carrier comprises an opening defined by the line of weakening defining the second removable patch in the second configuration of the carrier when the first plurality of panels and the second plurality of panels are folded.

34. The method of claim 23, wherein a front handle portion extends from the front central panel and a back handle portion extends from the back central panel, the front handle portion and the back handle portion are for forming a handle of the carrier when the first plurality of panels and the second plurality of panels are folded.

35. The method of claim 34, wherein a front handle reinforcement flap and a back handle reinforcement flap are for respectively overlapping with a respective front handle portion and a back handle portion when the first plurality of panels and the second plurality of panels are folded.

36. The method of claim 35, wherein the front handle reinforcement flap and back handle reinforcement flap are foldably separably connected at a portion of the line of weakening.

37. The method of claim 23, wherein at least one of the front portion of the blank and the back portion of the blank comprises an attachment flap foldably connected to a respective one of the front central panel and the back central panel, the attachment flap being adhesively attached to the other of the front central panel and the back central panel when the first plurality of panels and the second plurality of panels are folded, the front portion of the carrier and the back portion of the carrier remain foldably connected at the attachment flap in the second configuration of the carrier when the first plurality of panels and the second plurality of panels are folded.

38. The method of claim 23, wherein the front portion of the blank comprises at least one front divider flap foldably connected to at least one panel of the first plurality of panels, the front divider flap divides the front interior space into at least two front container-receiving spaces when the first plurality of panels and the second plurality of panels are folded.

39. The method of claim 38, wherein the back portion of the blank comprises at least one back divider flap foldably connected to at least one panel of the second plurality of panels, the back divider flap divides the back interior space into at least two back container-receiving spaces when the first plurality of panels and the second plurality of panels are folded.

40. The method of claim 39, wherein the at least one front divider flap is foldably connected to the front central panel and the at least one back divider flap is foldably connected to the back central panel when the first plurality of panels and the second plurality of panels are folded.

41. The method of claim 40, wherein the at least one front divider flap comprises a first portion foldably connected to the front panel and a second portion foldably connected to the first portion and the front central panel, the front divider flap forms a window in the front portion of the carrier when the first plurality of panels and the second plurality of panels are folded.

42. The method of claim 38, wherein the at least one front divider flap comprises a first front divider flap foldably connected to the front central panel and a second front divider flap foldably connected to the front panel, the first front divider flap is adhesively connected to the second front divider flap when the first plurality of panels and the second plurality of panels are folded.

43. The method of claim 23, wherein the first plurality of panels comprises a first front bottom panel foldably connected to the front panel and a second front bottom panel foldably connected to the front central panel.

44. The method of claim 43, wherein the second plurality of panels comprises a first back bottom panel foldably connected to the back central panel and a second back bottom panel foldably connected to the back panel.

45. The method of claim 44, wherein the first front bottom panel and the second front bottom panel cooperate to at least partially define the front interior space and the first back bottom panel and the second back bottom panel cooperate to at least partially define the back interior space when the first plurality of panels and the second plurality of panels are folded.
